(19) United States
(12) Patent Application Publication
(10) Pub. No.: US 2012/0229242 A1
(43) Pub. Date: Sep. 13, 2012

(54) JACKET MEMBER

(76) Inventors: Chao-Chin TENG, Taichung City (TW); Chi-Lu Li, Taichung City (TW); Chin-Chia Liu, Taichung City (TW)

(21) Appl. No.: 13/044,420

(22) Filed: Mar. 9, 2011

(51) Int. Cl. H01F 27/30

(52) U.S. Cl. 336/198

(57) ABSTRACT

A jacket member for fitting on a pole of a resolver stator. Enameled wires can be wound around the jacket member to indirectly form coils on the pole of the resolver stator. The jacket member includes a hoop body for fitting on the pole of the resolver stator, whereby the enameled wires can be wound around the hoop body to form the coils. The jacket member further includes multiple projections disposed on the hoop body and projecting therefrom. After the enameled wires are wound around the hoop body, the terminals of the enameled wires can be hooked and located on the projections.

### BACKGROUND OF THE INVENTION

1. Field of the Invention

The present invention relates generally to a resolver, and more particularly to a jacket member for fitting on a pole of a resolver stator. Enameled wires can be wound around the jacket member to form coils on the pole of the resolver stator.

2. Description of the Related Art

In the field of motor position control, various conventional position feedback techniques have been disclosed for precisely feeding back angular positions of a motor to a drive device as the basis for circuit control. For example, a resolver is used to achieve the purpose of motor position feedback. The resolver has the advantages of low cost and high resolution.

To speak more specifically, a conventional resolver is basically composed of a stator and a rotor. Excitation coils and induction coils are wound on the poles of the rotor and the stator. The excitation coils serve as excitation signal sources to provide excitation signals. When the rotor rotates relative to the stator, the magnetic field generated by the induction coils changes to output amplitude modulation signals and accordingly feed back signals of rotational position of the motor for controlling the motor.

With respect to the above conventional technique, the poles of the resolver lack suitable locating structure. Therefore, after the enameled wires are wound on the poles to form the coils, the terminals of the enameled wires must be manually bent and affixed to the surfaces of the coils by means of adhesion. Such manufacturing process is likely to cause a short circuit between the enameled wires. Moreover, such manufacturing process has poor stability and is troublesome. As a result, with the resolver serving as a signal source for precisely controlling the motor, the above shortcomings of the conventional technique will affect the reliability of the resolver and deteriorate the precision thereof.

### SUMMARY OF THE INVENTION

It is therefore a primary object of the present invention to provide a jacket member for fitting on a pole of a resolver stator. Enameled wires can be conveniently wound around the jacket member to indirectly form coils on the pole of the resolver stator. With the jacket member, the manufacturing process is simplified and the winding process can be automated.

It is a further object of the present invention to provide the above jacket member. After the enameled wires are wound around the jacket member, the terminals of the enameled wires can be hooked and located thereon. This simplifies the manufacturing process and enhances stability and reliability of the manufacturing process.

To achieve the above and other objects, the jacket member of the present invention includes a hoop body for fitting on the pole of the resolver stator. The enameled wires can be wound around the hoop body to form the coils. The jacket member further includes multiple projections disposed on the hoop body and projecting therefrom. After the enameled wires are wound around the hoop body, the terminals of the enameled wires can be hooked and located on the projections.

The present invention can be best understood through the following description and accompanying drawings, wherein:

### BRIEF DESCRIPTION OF THE DRAWINGS

FIG. 1 is a top perspective view of a preferred embodiment of the present invention;

FIG. 2 is a bottom perspective view of the preferred embodiment of the present invention;

FIG. 3 is a front view of the preferred embodiment of the present invention;

FIG. 4 is a perspective view showing that the preferred embodiment of the present invention is to be installed on a pole of a resolver stator;

FIG. 5 is a perspective view showing that the preferred embodiment of the present invention is installed on the pole of the resolver stator;

FIG. 6 is a plane view showing that the preferred embodiment of the present invention is installed on the pole of the resolver stator and the enameled wires are wound around the present invention to form the coils; and

FIG. 7 is a partially perspective view showing that the preferred embodiment of the present invention is installed on the pole of the resolver stator and the enameled wires are wound around the present invention to form the coils.

### DETAILED DESCRIPTION OF THE PREFERRED EMBODIMENT

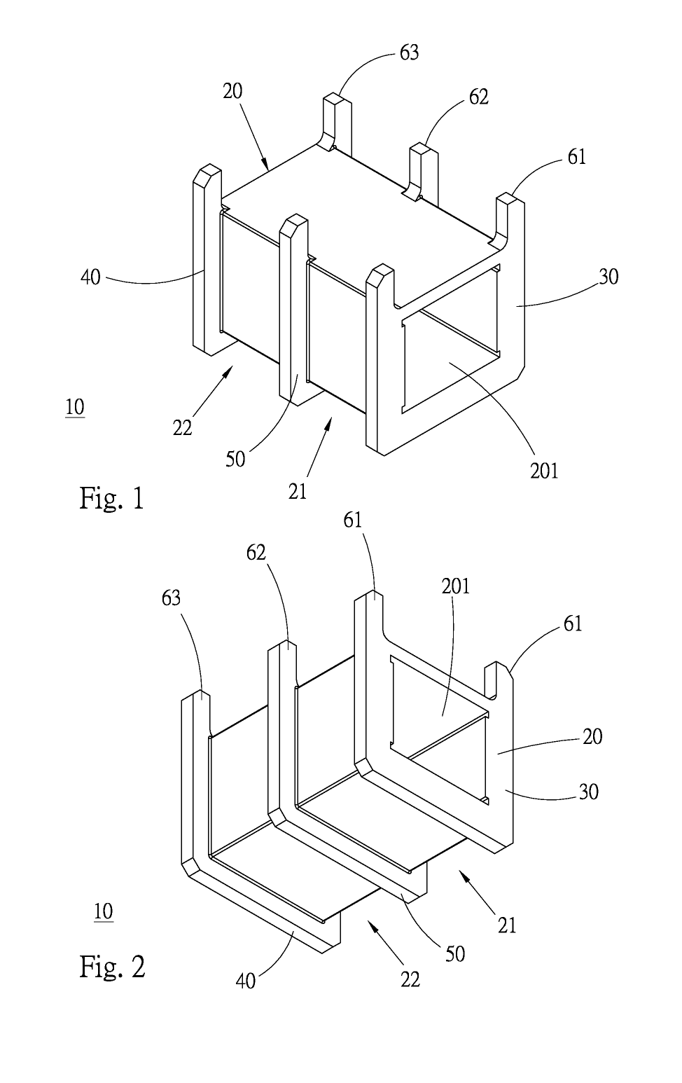

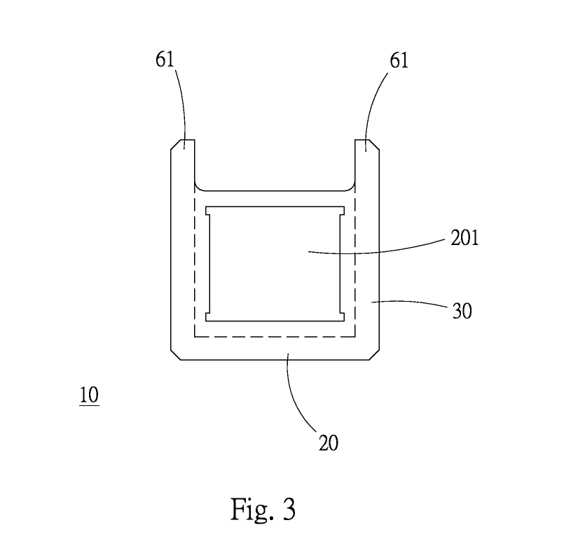

Please refer to FIGS. 1 to 3. According to a preferred embodiment, the jacket member 10 of the present invention includes a hoop body 20, a first end wall 30, a second end wall 40, a partitioning wall 50 and a first, a second and a third pairs of projections 61, 62, 63.

The hoop body 20 has a substantially rectangular sol id configuration and is formed with a quadrangular passage 201. The enameled wires can be wound around the hoop body 20 to form the coils.

The first and second end walls 30, 40 and the partitioning wall 50 have the form of U-shaped boards. The first and second end walls 30, 40 and the partitioning wall 50 are respectively integrally formed on the hoop body 20 in different positions and project from the hoop body 20. The first and second end walls 30, 40 and the partitioning wall 50 are arranged at intervals in parallel to each other.

To speak more specifically, the first end wall 30 radially outward extends from outer periphery of a first end of the hoop body 20, while the second end wall 40 radially outward extends from outer periphery of a second end of the hoop body 20.

The partitioning wall 50 radially outward extends from outer periphery of a middle section of the hoop body 20 between the first and second end walls 30, 40 in parallel thereto.

Accordingly, a first recessed section 21 is defined on the periphery of the hoop body 20 between the first end wall 30 and the partitioning wall 50 and a second recessed section 22 is defined on the periphery of the hoop body 20 between the second end wall 40 and the partitioning wall 50.

The projections 61, 62, 63 respectively integrally project from free ends of the U-shaped end walls 30, 40 and the U-shaped partitioning wall 50. To speak more specifically, the first pair of projections 61 outward extends from the free ends of the U-shaped first end wall 30 in parallel to each other. The second pair of projections 62 outward extends from the free ends of the U-shaped partitioning wall 50 in parallel to each other. The third pair of projections 63 outward extends from the free ends of the U-shaped second end wall 40 in parallel to each other.

According to the above arrangement, the enameled wires can be wound around the recessed sections 21, 22 of the jacket member 10 to form the coils. After the winding of the coils is completed, the terminals of the enameled wires can be hooked on some suitable projections and located. In this case, the winding process of the enameled wires can be automated.

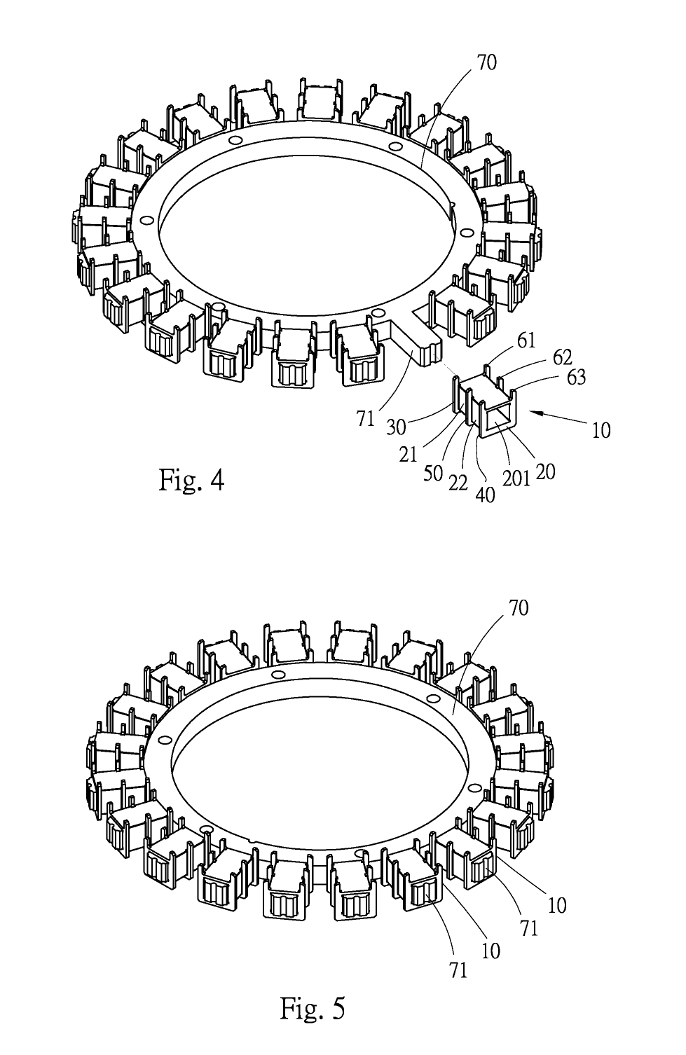

Please now refer to FIGS. 4 and 5. In use, the hoop body 20 of the jacket member 10 is fitted on a corresponding pole 71 of a resolver stator 70 with the pole 71 received in the quadrangular passage 201 of hoop body 20. The hoop body 20 can be easily fitted onto the pole of the stator and securely located thereon. The quadrangular passage 201 has, but not limited to, a configuration corresponding to that of the pole 71.

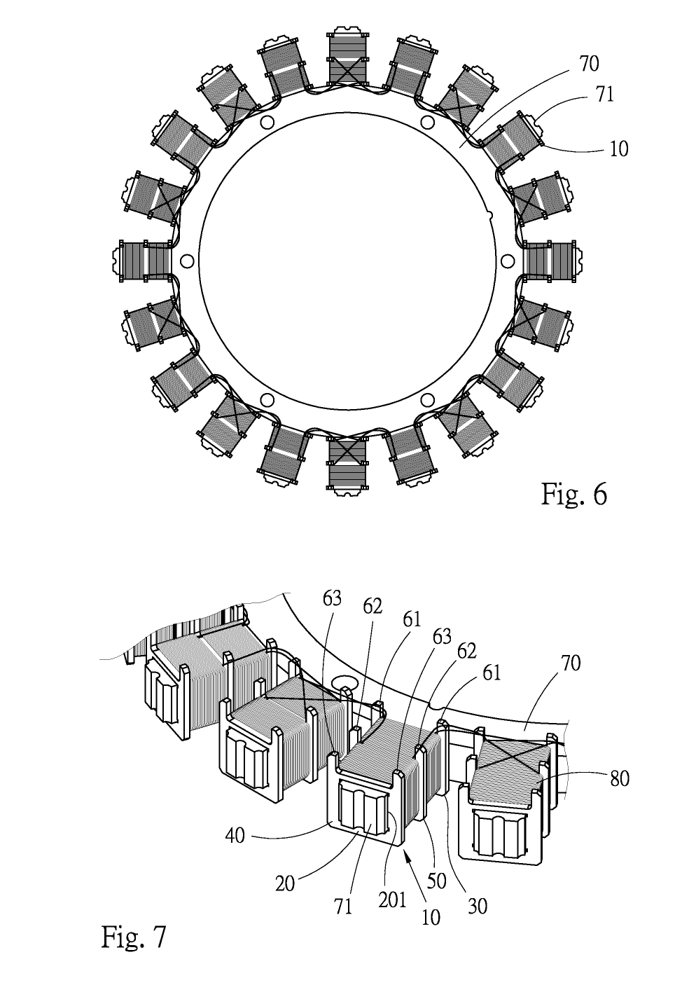

Please refer to FIGS. 6 and 7. After the jacket members 10 are fitted on the poles 71 of the resolver stator 70, the enameled wires 80 can be wound on the recessed sections 21, 22. After the winding process is completed, the terminals of the enameled wires 80 can be respectively wound over the first pair of projections 61 and fixedly hooked thereon. The terminals of the enameled wires 80 can be further extended to another jacket member 10 for successive winding process. Accordingly, the winding operation can be continued in an automated manner. This can overcome the problems existing in the prior art to simplify the manufacturing process and shorten working time. Also, the stability and reliability of the manufacturing process can be enhanced.

Finally, it should be noted that by means of the partitioning wall 50 of the jacket member 10, the enameled wires can be wound around different recessed sections 21, 22 to form the coils in a truly separated state. The first and second end walls 30, 40 serve to prevent the coils from detaching from the poles. Accordingly, the coils wound on the jacket member 10 are kept in a secure state.

The above embodiment is only used to illustrate the present invention, not intended to limit the scope thereof. Many modifications of the above embodiment can be made without departing from the spirit of the present invention.

What is claimed is:

1. A jacket member comprising:
a hoop body around which enameled wires can be wound to form coils; and
multiple projections disposed on the hoop body and projecting therefrom, whereby after the enameled wires are wound around the hoop body, terminals of the enameled wires can be hooked and located on the projections.

2. The jacket member as claimed in claim 1, further comprising a first end wall, which radially outward extends from a first end of the hoop body.

3. The jacket member as claimed in claim 2, further comprising a second end wall, which radially outward extends from a second end of the hoop body.

4. The jacket member as claimed in claim 3, further comprising a partitioning wall between the first and second end walls, the partitioning wall radially outward extending from a middle section of the hoop body.

5. The jacket member as claimed in claim 2, wherein the number of the projections is two and the two projections symmetrically radially outward extend from the first end wall of the hoop body.

6. The jacket member as claimed in claim 3, wherein the number of the projections is two and the two projections symmetrically radially outward extend from the first end wall of the hoop body.

7. The jacket member as claimed in claim 4, wherein there are two pairs of projections, a first pair of projections symmetrically radially outward extending from the first end wall of the hoop body, while a second pair of projections symmetrically radially outward extending from the partitioning wall of the hoop body.

8. The jacket member as claimed in claim 4, wherein there are three pairs of projections, a first pair of projections symmetrically radially outward extending from the first end wall of the hoop body, a second pair of projections symmetrically radially outward extending from the partitioning wall of the hoop body, while a third pair of projections symmetrically radially outward extending from the second end wall of the hoop body.

9. The jacket member as claimed in claim 1, wherein the hoop body substantially is a hollow rectangular solid body.

10. The jacket member as claimed in claim 9, wherein the hoop body is formed with a quadrangular passage.
